(19) United States
(12) Patent Application Publication
(10) Pub. No.: US 2007/0203262 A1
(43) Pub. Date: Aug. 30, 2007

(54) Composite building material produced from reclaimed thermoplastic powders and recycled glass

(76) Inventor: John W. Crossley, Upper Black Eddy, PA (US)

Correspondence Address: Armand M. Vozzo, Jr., 19 Short Road, Doylestown, PA, 18901, US

(21) Appl. No.: 11/364,763

(22) Filed: Feb. 28, 2006

(51) Int. Cl. C08K 9/06; C08K 3/40

(52) U.S. Cl. 523/214; 524/494

(57) ABSTRACT

An improved heat-cured composite material for casting building products is disclosed together with an associated method of making same from a dry mixture of reclaimed thermoplastic powders and selectively-formed particles of recycled glass, the recycled glass particles being ground into irregular shapes having non-rounded edges and sorted by size before being deposited with a silane coating. The recycled glass particles can range in size from ¾″ mesh to 100 mesh and may be employed in substantially similar sizes within a single batch mixture of the material or in a combination of differing mesh sizes to selectively vary the mechanical properties of the composite material and its resultant product. The reclaimed thermoplastic powders are screened for contaminants and treated with compatibility agents as necessary prior to mixture with the glass particles. Minor portions of a flame retardant material and a coloring agent may be further added and blended to the mixture prior to casting. Upon blending, the mixture of the composite material is placed in an object specific mold corresponding to the resultant product and heated gradually to the curing temperature of the thermoplastic powders, typically about 350° F., for a specified dwell time before any surface treatment is applied and the product released from the mold.

### BACKGROUND OF THE INVENTION

The present invention relates to the production of composite materials from recycled components, and more particularly to an improved heat-cured composite material and method for producing same from reclaimed thermoplastic powders and recycled glass that are pre-treated before blending in predetermined proportions and molding into roofing and cladding panels and other useful building products that are comparatively lightweight, strong and aesthetically pleasing in appearance.

The utilization of recycled materials, such as glass, metal and plastics, has been promoted over the past few decades to preserve natural resources and protect the environment, with the recycling efforts being further fostered by the hope of cost reductions in the articles produced by the recycled materials. While the economics of using recycled materials have yet to be consistently proven, the protection of our environment and preservation of our natural resources continue to favor the recycling of industrial materials and the development of new ways of incorporating those recycled materials into useful products.

The building construction industry has in recent years turned its attention to the use of recycled materials not only for environmental reasons but also in search of effective synthetic alternatives to particularly high-end natural materials, such as slate, cedar and clay, long used to make roofing, siding and other traditional building products. A variety of such synthetic building materials have been developed and made in substantial part from recycled materials including rubber, glass, and thermoplastic resins. For instance, the effective reuse of “crumb rubber” particles in a roofing shingle product is indicated in U.S. Pat. No. 6,194,519. Recycled glass has been frequently employed and incorporated into various building products primarily as reinforcement fibers and fillers. Thermoplastic resin scrap material in a post-cured state has too been reutilized in the production of finished or semi-finished products usable in the construction industry. While mixtures of such thermoplastic scrap containing different resin types and formulations have been subject to incompatibility problems that can manifest themselves in the finished product having inferior physical and/or mechanical properties, prior art has demonstrated certain compatibilizing techniques that result in the exhibit of improved properties in articles produced thereby. See, for example, U.S. Pat. No. 4,250,222 for techniques known to compatibilize mixtures of different post-cured thermoplastic resin scrap.

Another type of thermoplastic material available for reutilization in material manufacturing is that of a pre-cured variety found in the form of powders that are reclaimed after spraying and failing application upon a substrate surface in industrial powder coating processing. These thermoplastic powders are generally applied to substrates in booths by electrostatic or flock spraying, the substrate being preheated to a temperature significantly higher than the melting point of the powder so that upon impacting the surface of the substrate, the powder melts and bonds by fusion to the surface. The powders that miss the substrate by overspray or by down draft loss are recovered, collected and reclaimed for potential reapplication in coatings. In most cases, however, the reclaimed thermoplastic powders are not reused due to the risk of contamination and the reclaimed powders are stored in drums and disposed of in landfills. In the automotive industry alone, thousands of tons of these reclaimed thermoplastic powders are disposed of annually with a resultant loss of energy costs and wasted raw materials. Despite these substantial losses and the costs associated with their disposal, there is no known means or methodology apparent in the prior art for the effective processing of reclaimed thermoplastic powders, even when contaminated and commingled in their collected quantities, in order to produce a new composite material useful in building construction.

### SUMMARY OF THE INVENTION

Accordingly, it is a general purpose and object of the present invention to provide a new and useful method for reusing reclaimed thermoplastic powders recovered as waste material from industrial coating operations.

A more particular object of the present invention is to provide an improved method of making a composite building material from reclaimed thermoplastic powders pretreated and formulated together with other components to produce useful articles for building construction.

Another object of the present invention is to provide an improved composite building material produced from reclaimed thermoplastic powders processed and combined in formulations that may be heat cured and cast into roofing, cladding and other surface panels and support members used in building construction.

Still another object of the present invention is to provide an improved heat-cured composite material made from reclaimed thermoplastic powders that can be manufactured and used for a variety of building products made to comply with applicable building codes.

A still further object of the present invention is to provide an economical method for incorporating reclaimed thermoplastic powders into a composite building material capable of producing comparatively strong lightweight and aesthetically appealing products.

Briefly, these and other objects of the present invention are accomplished by an improved heat-cured composite material for casting building products and an associated method of making same from a dry mixture of reclaimed thermoplastic powders and selectively-formed particles of recycled glass, the recycled glass particles being ground into irregular shapes having non-rounded edges and sorted by size before being deposited with a silane coating. The recycled glass particles can range in size from ¾″ mesh to 100 mesh and may be employed in substantially uniform sizes within a single batch mixture of the material or in a combination of differing mesh sizes to selectively vary the mechanical properties of the composite material and its resultant product. The reclaimed thermoplastic powders are screened for contaminants and treated with compatibility agents as necessary prior to mixture with the glass particles. Minor portions of a flame retardant material and a coloring agent may be further added and blended to the mixture prior to casting. Upon blending, the mixture of the composite material is placed in an object specific mold corresponding to the resultant product and heated gradually to the curing temperature of the thermoplastic powders, typically about 350° F., for a specified dwell time before any surface treatment is applied and the product released from the mold.

For a better understanding of these and other aspects of the present invention, reference should be made to the following detailed description taken in conjunction with the accompanying drawings in which like reference numerals and characters designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a general block diagram illustrating the method for making the present composite material and resultant articles in accordance with the present invention;

FIGS. 2A to 2C are schematic sectional illustrations showing the stages of a mold formation of the present composite material during heat-curing; and

FIGS. 3A and 3B are perspective views from opposite sides of a resultant article, in this case a roofing tile product, molded from the composite material in accordance with the present invention.

### DETAILED DESCRIPTION OF THE INVENTION

The following is a detailed description of a preferred embodiment of the present invention and the best presently contemplated mode of its production and practice. This description is further made for the purpose of illustrating the general principles of the invention but should not be taken in a limiting sense, the scope of the invention being best determined by reference to appended claims.

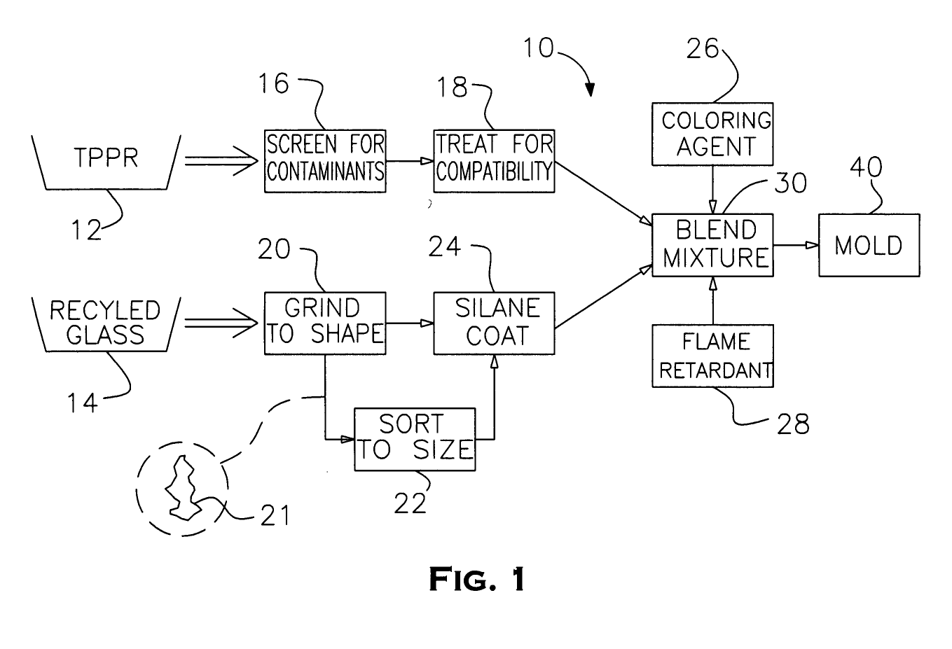

Referring to FIG. 1, the present invention comprises a unique process, generally designated as 10, for combining respective supplies of thermoplastic powder reclaim (TPPR) 12 and recycled glass material 14 to produce an improved composite material that may be heat-cured and molded into products specifically useful in building construction. The supply of TPPR 12 is primarily available as waste material from industrial powder coating systems, the TPPR typically being over-sprayed powders that do not attach to a substrate target and that in turn are collected in reclaim bins or the like for intended disposal. The TPPR supply 12 suitable for use in the present invention may consist of those thermoplastic powders, such as epoxies, urethanes, acrylics and various hybrid polymers, that are designed to cross link under heat-curing conditions ranging from 300° to 450° F., as well as those thermoplastic powders such as vinyls, nylons, and fluorocarbons, that do not cross link when cured but rather that are designed to simply melt under curing conditions and then harden upon cooling. Because of the variety of types of thermoplastic powders generally used and available as TPPR, it is important to identify the composition of the available TPPR supply 12 and when possible, to segregate and selectively employ TPPR of similar polymeric composition. Often this is not the case, and epoxy, polyester, and/or acrylic powders will be found combined in the same TPPR. As is described in greater detail below, the present invention deals with this characteristic combination of TPPR types and eliminates the resulting compatibility problems that can occur by an addition, when necessary, of polymer compatibility agents in treatment step 18 and further by the use of irregular non-rounded glass particles 21 found to relieve out-gassing reactions of incompatible polymers during heat-curing.

Since TPPR is subject to contamination by foreign materials in their recovery and due to their fine particle size (typically 200 to 350 mesh), further subject to clumping by humidity and by separation of inert fillers in their composition, the TPPR supply 12 should be initially subjected to a screening step 16 that includes remixing, sifting and drying, if possible, prior to mixing in combination with the recycled glass material 14.

The supply of recycled glass material 14 may be provided in many forms, such as from flat glasses, used bottles from the contained industry and furnace cullet, and further may be of various types, including soda lime and borosilicate glasses. Regardless of the type or form of the source glass material, the supply of recycled glass 14 is subjected to an initial grinding step 20 intended to produce glass particles 21, as depicted in FIG. 1, that are irregular in shape with a fractured, non-rounded edge. For effective use in the present invention, the glass particles 21, as produced in their irregular shapes with non-rounded edges, are preferred in sizes from ¾″ mesh to 100 mesh, determined according to U.S. Sieve No./Wire Mesh Size standards, and are sorted to size in step 22 upon grinding. To produce the described glass particles 21 in their shape and respective sizes, the grinding step 20 is accomplished by conventional hammer mill and steel plate grinders rather than by suspension grinding, which typically produces a more rounded edge particle. The sorting step 22 is accomplished by conventional screening and may be conducted as part of the grinding step 20 or separately as a secondary screening process. It should be noted that the sizes of the glass particles 21 employed in the present invention affect the physical and/or mechanical properties of the composite material produced thereby, and together with the proportionate weight ratios of the recycled glass to TPPR in mixture, are determinative of the type and quality of the resultant product molded from the composite material of the present invention. Regarding particle size selections made according to the present invention, it should be further noted and understood that the glass particles 21 may be uniform or substantially similar in their size range within a single batch mixture of the present composite material or may be selectively varied in different mesh size ranges that are combined in the mixture to vary the mechanical properties of the composite material and determine those of the resultant product.

Since the recycled glass serves primarily as an aggregate in the present composite material produced in accordance with the present invention, it is not necessary to segregate the various types of recycled glass materials for the starting supply 14 herein. However, since recycled glass is normally found contaminated with both organic and inorganic contaminants, it is essential to remove these contaminants from the ground glass particles 21 and/or modify their chemical effect prior to blending the particles in mixture with the processed TPPR and other components of the present invention. As for inorganic contaminants, recycled glass materials for the starting supply 14 will often be found decorated with fired-on inorganic oxides that will generally brake free in the grinding step 20. Organic contaminants, however, including label materials, glues and other organic residues, will need further treatment to remove them from the ground glass particles 21 prior to mixture in the present invention. Accordingly, to both clean the recycled glass of organic contaminants and prepare the ground glass particles 21 for improved bonding in mixture with the TPPR, a silane-coating step 24 is conducted upon the selected glass particles in accordance with the present invention.

Silane is a chemical compound with chemical formula SiH₄ and is the silicon analogue of methane. More generally, a silane is any silicon analogue of an alkaline hydrocarbon. As a molecular group, silanes consist of a chain of silicon atoms covalently bound to hydrogen atoms, the general formula for a silane group being SiₙH₂ₙ₊₂. Silanes are known and used in industrial applications as adhesion promoters in paint and coating formulations and as coupling agents in the fiberglass industry to adhere the glass fibers to organic bonding agents within a given polymer matrix, the adhesion qualities being attributable to the unique structure of the silane molecule which has both organic and inorganic reactivity allowing it to couple with both organic polymers and inorganic surfaces. A silane coating treatment 24 applied by way of washing with a silane alcohol solution, such as glycidoxy methoxy silane produced by Dow Corning, provides greater compatibility between the organic polymers of the TPPR and the inorganic surfaces of the glass particles 21. More specific to the silane coating step 22 in the present invention, the selected ground glass particles 21 are placed in a silane alcohol solution, the preferred ratio being about 5 pounds of the glass particles to 1 gallon of the solution, and the combination is agitated by tumbling in a roller drum or the like. In the tumbling, the solvent activity of the alcohol along with the abrasive nature of the ground glass particles 21 begins to remove the contaminants, which in turn become suspended in the solution. At this point, the silane is siphoned off along with the contaminants and filtered for repeat use. The glass particles 21 are removed from the remaining solution and dried on screens where excess silane may percolate through the glass to be collected below the drying screens. Since the solution is alcohol based, the glass particles 21 dry quickly with a uniform coating of a silane primer on each. The silane primer will also coat any of the remaining inorganic contaminants not separated from the ground glass particles 21 and allow them to bond to the TPPR matrix. It should be noted that the elongated fractures of the glass particles 21 provide greater and more complex surface areas for the silane coating to adhere to as opposed to more rounded particles. This results in increased composite tensile strength as well as increased flexural strength and modulus exhibited by the composite material.

After being provided with the silane coating, the recycled glass particles 21 are blended with the pre-screened and treated TPPR in a dry batch mixing process 30. The coated glass particles 21 in the sizes sorted and selectively determined for the desired resultant product are blended with the TPPR in various proportions by weight of between about 40-70% glass particles and between about 30-50% TPPR. Since normal supplies of recycled glass and TPPR each will have varied specific weights and gravities, it is important to qualify the proportions of the respective components blended in the present composite material mixture based upon the product intended to be developed. Furthermore, by controlling the size of the glass particles 21 blended in the mixture, either in a substantially uniform size range or in a combination of different size ranges, the desired mechanical properties and/or physical characteristics of the intended composite material product can be achieved. In regard to the varied proportions of the recycled glass and TPPR in the composite material mixture, higher weight ratios of the glass particles 21 to the TPPR, approximately 2:1 or more, are suitable for casting resultant products that are strong but not needing specific surface detail or finished texture, such as support block or panel members. Lower weight ratios of glass to TPPR in the range of about 1:1 are preferred for resultant products that require greater surface detail and texture as provided by object specific molds.

As for effective sizes of the recycled glass particles 21 in the composite mixture, the use of fine, medium and coarse particles is contemplated, the fine particles being conventionally less than about 0.50 mm or sized between 35 to 100 mesh according to the present invention, the medium particles being 0.50-1.50 mm or between about 14 to 35 mesh, and the coarse particles being above 1.50 mm or above 12 mesh in the present invention. Smaller sizes of the glass particles 21, being predominantly fine or a combination of fine and medium particles, are selected and used to make a composite material product that is denser and more malleable, and as a result, capable of being machined, drilled or nailed, such as in the case of roofing tiles and shingles. It is important here to note that the ratio of fine and medium sized recycled glass particles 21 should be at least 75% of the total recycled glass particles in the mixture if the composite material product is to be drilled or nailed, as in the case of roofing materials, shutters and the like. Larger particle sizes, being predominantly coarse or a combination of coarse and medium particles, are used to develop a higher structural strength in the resultant composite material product and are more suitable for casting large blocks and panels. For example, a strong block or panel member is created in accordance with the present invention by a blended mixture of 45% TPPR by weight and 45% by weight of recycled glass particles 21, the balance of the mixture being a flame retardant powder, as described below, and the recycled glass particles being a combination of predominantly coarse and medium sizes.

Since the resultant products are generally those intended for use in building construction and the thermoplastic powders contained in the TPPR component are highly flammable unless modified, the present invention contemplates an additive, indicated in step 28, of a dry, flame retardant powder material, such as aluminum trihydrate, in proportions of up to 10% by weight. The aluminum trihydrate, for example, is a fine powder, typically between 20 to 30 microns, which can be encapsulated by the thermoplastic powders at about 350° F. without adversely affecting its ability to prevent the TPPR from igniting during the heat curing of the composite material described below. This preventive feature is the result of the release of water vapor from the aluminum trihydrate at ignition temperature of 220° C. The recycled glass material in the particles 21 added to the blended mixture also acts as a flame retardant of sorts by reducing amounts of cured thermoplastic resin in the resultant product and further acts as a heat sink in the composite material. Other known and commercially available flame retardant powders, such as aluminum sulfate, may also be used alone or in conjunction with the aluminum trihydrate.

Another contemplated addition to the blended mixture of the present invention is that of a coloring agent 26 intended to provide a uniform color to the composite material in a desired shade appropriate for the resultant building product made therefrom. The addition of the coloring agent 26 is particularly contemplated where the TPPR is recovered in a variety of colors and combined in multiple batches of reclaim supply. For general purposes in coloring the present composite material, a uniform shade of a dark gray or black is provided and can be achieved by the addition of a carbon black agent at a proportion of up to 5% by weight. For color sensitive products of the present composite material, clear TPPR, which is commonly available, can be dyed with various inert dye stuffs, such as calcium carbonate or titanium dioxide, or by the addition of small percentages (5.0% or less) of specific dry polymer dye stuffs.

The blending process 30 is most effectively conducted in a conventional dry batch-blending unit of the roller drum or tumbler type. With the silane-washed glass particles 21 and the pre-screened TPPR combined together in their respective major proportions and the flame retardant powder and coloring agent further added, the batch mixture of the composite material is tumbled until a uniform dispersion is achieved, typically for a period of about 20 minutes. The uniformly dispersed mixture is then prepared and ready for the molding stage 40, the mixture being initially poured and/or shaken into silicone rubber molds or molds of ceramic or metal that are coated with silicone rubber material to prevent adhesion of the thermoplastic resins in the TPPR to the mold forms. The molds are constructed and formed to be object specific and thus are intended for use in casting a specific type of building product, such as a roofing tile or shingle or a cladding panel, having characteristic dimensions of length, width and thickness. The silicone rubber preferred for the mold construction or coating should be such that the material can withstand repeated heat cycles of up to 400° F. As such, the preferred silicone rubber molds should require no further mold release agents.

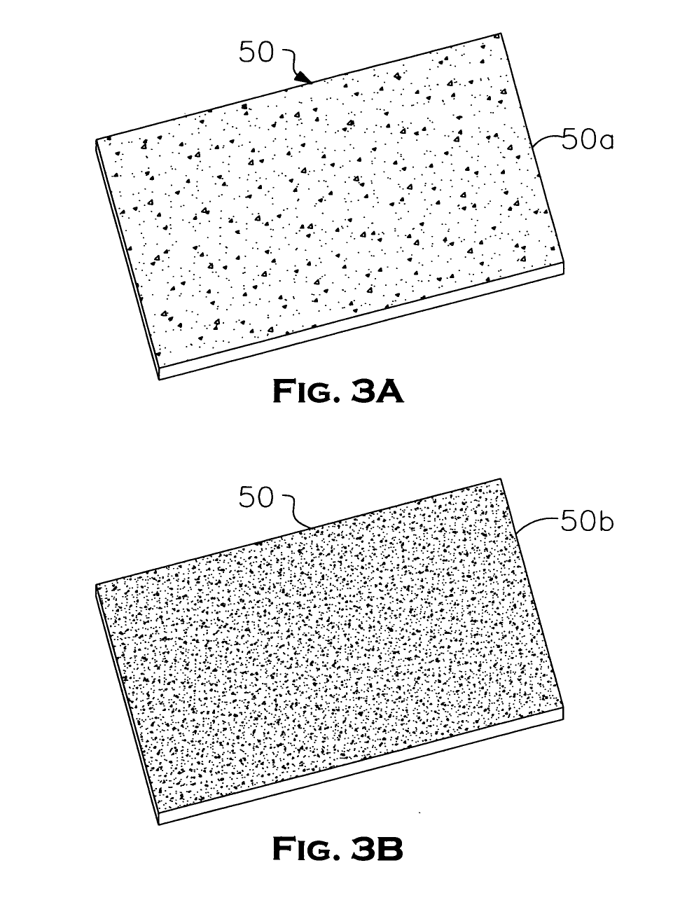

To obtain uniformity of thickness, the blended mixture of the present composite material, after being poured and shaken in the mold, is then compacted to level or screte the top surface of the material within the mold using conventional screte tools. This compaction will allow the material to pick up and reflect any desired detail or surface contour appearing on the mold surface. When charged and loaded with the composite material, the molds are placed on trays in a batch furnace or oven or transferred by conveyor through a belt furnace or oven and heat cured to 350° F. for a predetermined dwell time of between 20 minutes to an hour depending upon the thickness of the desired product. Once the predetermined dwell time is completed, the mold and its contained product are removed from the molding furnace or oven and allowed to cool before demolding of the product part. Cooling may be accelerated by air or water spray to hasten the demolding. For some resultant products, such as a roofing tile 50, shown in FIGS. 3A and 3B, an additional coating of an aqueous latex rubber can be applied by spraying or screting the latex rubber onto the exposed back surface 50b of the tile to produce a vapor barrier thereon which is cured by the residual heat of the tile before demolding. It is contemplated that after cooling down and demolding, any resultant product may be further finished, as deemed necessary, by grinding, drilling or milling.

For a better understanding of the present invention, the following specific examples are given as effective formulations of the present composite material and the associated resultant products formed thereby:

### EXAMPLE I

### Roofing Tile

Blend a combination of dried silane-washed glass particles in medium-to-fine sizes of 18 to 35 mesh with pre-sifted clear TPPR in weight proportions of 40% TPPR and 60% recycled glass particles. Add 8% by weight of aluminum trihydrate as a flame retardant and add about 1% by weight of carbon black to provide a uniform slate color. Blend the mixture in a roller drum and tumble for approximately 20 minutes until uniform dispersion is observed. Pour and shake the blended mixture in object specific molds of silicone rubber, each having a rectangular configuration and a textured surface to simulate the contours of natural slate, and level mixture in the mold at approximately ¼″ thickness. Mold in conveyor furnace for 30 minutes of dwell time at 350° F. After exiting the furnace, a coating of aqueous latex rubber can be applied onto the unfinished side of the tile in the mold and allow to cure before demolding. The resultant product is a simulated slate roofing tile that is flame retardant and UV stable. The roofing tile is slightly flexible and able to be installed by nailing to conventional roof sheathing. The flexibility of the resultant tile product and its ability for nailing is a result of the glass particle size and the ratio of TPPR to glass, along with the higher modulus of flexibility provided by the silane wash and coating.

### EXAMPLE II

### Cladding/Sheathing Panel

Blend a combination of the TPPR and the silane-coated glass particles together with the flame retardant powder in weight proportions as follows:

50% TPPR;

25% glass particles of 8 to 14 mesh size;

20% glass particles of 4 to 7 mesh size; and

5% aluminum trihydrate.

In these stated proportions, the mixture of the TPPR and the selectively sized recycled glass particles allow large panels of up to 5′×10′ in size to be produced for cladding or sheathing applications. This is due to the higher proportion of TPPR and the larger glass particle sizes in the mixture. This formulation of the composite material can be cast and cured in thicknesses from ¼″ to 1″ and when heated to 350° F. for 1 hour, a very strong panel is produced having an impermeable smooth surface on one side reflective of the mold surface and an opposite side having a roughened surface. The larger glass particles allow for more gas evacuation during heat curing and greater thicknesses can be achieved. The silane coating also allows for sufficiently strong bonding of the larger glass particles to the TPPR, thus preventing an over migration of the fluent TPPR to the bottom of the mold during heat curing.

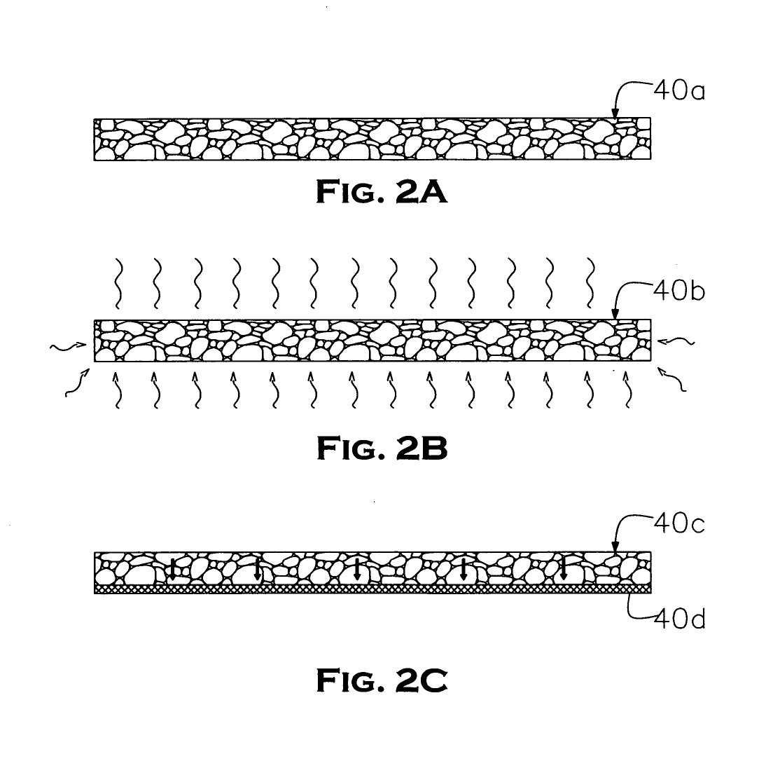

Referring now to FIGS. 2A-2C together with FIGS. 3A and 3B in conjunction with FIG. 1, the heat curing of the present composite material is initiated with a charged mold 40a packed with a blended mixture of TPPR and silane-coated glass particles 21 as its major components. As the charged mold becomes a heated unit 40b in FIG. 2A, typically in the range of about 250° F., gas evacuation or out-gassing occurs and the TPPR and glass particles 21 begin to flow together, the level of out-gassing being affected by the proportional amount of the TPPR to the recycled glass and the size of the glass particles. Increased levels of out-gassing are generated by relatively higher ratios of TPPR-to-glass in the composite mixture as well as by larger mesh sizes of the glass particles, the higher levels of out-gassing tending to result in the formation of a composite material product that assumes greater surface detail from the mold. As the heated mold reaches its dwelling temperature between 325°-350° F., as shown in FIG. 2C, the curing composite material 40c becomes more dense in its composition with the fluent TPPR migrating toward the bottom mold surface (as indicated by the arrows) where the migrated TPPR advances to form a surface layer 40d that mirrors the contoured texture designed into the mold. After completion of the requisite dwell time for heat curing of the composite material and a further period allowed for cooling, the resultant product, the roofing tile 50 depicted in FIGS. 3A and 3B, is removed from the mold to present a dense composite having a finished, textured side 50a reflective of the surface design on the bottom of the mold and an unfinished, granulated side 50b that formed in curing upon the top of the composite material across the open end of the mold.

In an alternate to the dry batch mixture of the present composite material described above, the silane component may be incorporated by utilizing the silane solution as a wetting agent wherein the recycled glass particles 21 and the TPPR are mixed into a paste suitable for extruding, rolling and flattening, or processing through a conventional plug mill. In this wet mixture of the present composite material, a 20% by volume composition of silane in solution is employed in conjunction with the combined blend of recycled glass particles 21 and TPPR in admixture. In the process of heat curing the resulting paste in the molding stage, this wet mixture of the composite material is dried by the process temperatures as the alcohol carrier of the silane solution will dissipate before reaching the 350° F. curing temperature, with the length of the dwell time being proportionate to the thickness of the desired product. This utilization of the silane as a wetting agent and the resultant wet mixture formulation of the present composite material are particularly suitable for building products such as barrel roofing slates, tubing members and other extrudable or wet pressed forms.

Therefore, it is apparent that the described invention generally provides a new and useful method for reusing reclaimed thermoplastic powders recovered as waste material from industrial coating operations. More particularly, the present invention provides an improved method of making a composite building material from reclaimed thermoplastic powders pretreated and formulated together with other components to produce useful articles for building construction. The described formulation and method of its preparation provides an improved composite building material that is able to be heat cured and cast into roofing, cladding and other surface panels and support members used in building construction. In addition, the described heat-cured composite material produced from recycled components can be manufactured and effectively used for a variety of building products made in compliance with standard specifications and applicable building codes. The present invention further provides an economical method for incorporating recycled components, particularly reclaimed thermoplastic powders, into a composite building material capable of producing comparatively strong lightweight and aesthetically appealing products.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Accordingly, it is understood that this invention is not limited to the particular embodiment described, but rather is intended to cover modifications within the spirit and scope of the present invention as expressed in the appended claims.

What is claimed:

1. A composite building material, comprising in mixture:
an effective amount of reclaimed thermoplastic powders of similar polymeric composition; and
an effective amount of recycled glass particles formed in irregular shapes having fractured, non-rounded edges, the recycled glass particles being sized in a predetermined range and further coated with a silane material.

2. A composite building material according to claim 1, wherein:
said effective amount of reclaimed thermoplastic powders is between about 30% to about 50% by weight of the mixture; and
said effective amount of recycled glass particles is between about 40% to about 70% by weight.

3. A composite building material according to claim 2, wherein the recycled glass particles are sized between about ¾″ inch and 100 mesh.

4. A composite building material according to claim 3, wherein the recycled glass particles are substantially similar in size within the predetermined range.

5. A composite building material according to claim 3, wherein the recycled glass particles are selectively varied in size and combined in predetermined proportions.

6. A composite building material according to claim 2, wherein the reclaimed thermoplastic powders are screened to remove contaminants therefrom and treated to reduce incompatible polymeric components therein.

7. A composite building material according to claim 6, further comprising:
an effective amount of a flame retardant powder material.

8. A composite building material according to claim 7, wherein the effective amount of the flame retardant powder material is up to about 10% of the mixture by weight.

9. A composite building material according to claim 7, further comprising:
an effective amount of a coloring agent to provide a substantially uniform color to the mixture in a desired shade.

10. A composite building material according to claim 9, wherein the effective amount of the coloring agent is up to about 5% of the mixture by weight.

11. A composite building material produced from recycled glass and reclaimed thermoplastic powders by a process comprising the steps of:
grinding the recycled glass into particles formed having irregular shapes with fractured, non-rounded edges;
coating the recycled glass particles with a silane material;
blending the coated glass particles in mixture with the reclaimed thermoplastic powders in predetermined proportions by weight, the reclaimed thermoplastic powers selected having a similar polymeric composition; and
heat-curing the blended mixture in a mold.

12. A composite building material produced according to claim 11, wherein prior to the coating step, the recycled glass particles are selectively sorted in sizes ranging between about ¾″ and 100 mesh.

13. A composite building material produced according to claim 12, wherein the recycled glass particles are substantially similar in their size.

14. A composite building material produced according to claim 12, wherein the recycled glass particles are varied in their sizes and combined in predetermined proportions based upon the sizes thereof.

15. A composite building material produced according to claim 12, wherein prior to the blending step, the reclaimed thermoplastic powders are screened to remove contaminants therefrom and treated to reduce incompatible polymeric components therein.

16. A composite building material produced according to claim 11, wherein:
the predetermined proportion of recycled glass particles is between about 40% to about 70% by weight in the blended mixture; and
the predetermined proportion of the reclaimed thermoplastic powders is between about 30% to about 50% by weight.

17. A composite building material produced according to claim 16, further comprising the step of:
adding an effective amount of a flame retardant powder material to the blended mixture prior to heat-curing to reduce flammability.

18. A composite building material produced according to claim 17, further comprising the step of:
adding an effective amount of a coloring agent to the blended mixture prior to heat-curing to provide a substantially uniform color to the building material in a desired shade.

19. A method for making a building product from recycled glass and reclaimed thermoplastic powders, comprising the steps of:
forming the recycled glass into particles having irregular shapes with fractured, non-rounded edges;
sorting the recycled glass particles in ranges of sizes between about ¾″ and 100 mesh;
coating the recycled glass particles with a silane material;
blending the coated glass particles in mixture with the reclaimed thermoplastic powders in predetermined proportions by weight, the reclaimed thermoplastic powers selected having a similar polymeric composition; and
heat-curing the blended mixture in an object specific mold corresponding to the desired building product.

20. A method according to claim 19, wherein:
the predetermined proportion of recycled glass particles is between about 40% to about 70% by weight in the blended mixture; and
the predetermined proportion of the reclaimed thermoplastic powders is between about 30% to about 50% by weight.

21. A method according to claim 20, wherein the recycled glass particles are substantially similar within a single range of sizes.

22. A method according to claim 20, wherein the recycled glass particles are in a multiple range of sizes and are combined in predetermined proportions based on size of the particles.

23. A method according to claim 19, further comprising:
adding an effective amount of a flame retardant powder material to the blended mixture prior to heat-curing to reduce flammability.

24. A method according to claim 23, further comprising:
adding an effective amount of a coloring agent to the blended mixture prior to heat-curing to provide a substantially uniform color to the building product in a desired shade.
